(19) United States
(12) Patent Application Publication
(10) Pub. No.: US 2014/0051056 A1
(43) Pub. Date: Feb. 20, 2014

(54) Electronic Training and Certification System

(71) Applicant: Leslie Restaino, Basking Ridge, NJ (US)

(72) Inventor: Leslie Restaino, Basking Ridge, NJ (US)

(21) Appl. No.: 13/895,466

(22) Filed: May 16, 2013

Related U.S. Application Data
(60) Provisional application No. 61/650,573, filed on May 23, 2012.

(51) Int. Cl. G09B 5/06

(52) U.S. Cl. CPC G09B 5/065
USPC 434/362

(57) ABSTRACT

The present invention relates to the field of electronic teaching and certification systems, and more specifically, provides systems for delivering educational content, ascertaining learning progress, and, utilizing adaptive learning systems, redirecting the learner to various iterations of the content to meet the varying needs and learning preferences of the learner. The invention further provides competency assessments which determine if a user has attained a particular learning target identified by the system, and awards a certification based on achievement of the learning target.

### BACKGROUND OF THE INVENTION

The present invention relates to the field of electronic teaching and certification systems, and more specifically, provides systems for delivering educational content, ascertaining learning progress, and redirecting the learner to various iterations of the content until the learner satisfies pre-determined learning criteria.

Computerized learning systems are widely used tools. In educational environments, instructors utilize these systems to provide content as useful adjuncts to course materials or, in other settings, to provide complete course content. In other instances, businesses or governmental agencies use them to share knowledge on certain issues.

Many industries are highly regulated. Working in these industries requires compliance with a myriad of regulations and laws; satisfactory compliance requires that all organization employees exhibit some level of competency on these regulations and laws. For example, the pharmaceutical industry has numerous regulations relating to pharmaceutical development and manufacturing, and numerous laws applicable to pharmaceutical manufacturer activities. Likewise, the healthcare industry is subject to numerous regulations and laws.

Adaptive learning systems address the fact that individuals learn differently by adapting the presentation of learning content to meet the varying needs and learning preferences of different individual learners. Computer based learning can be quite beneficial in adaptive learning situations as the computer can adjust or adapt to fit the needs of different types of learners. Various technical approaches used in adaptive and intelligent web-based educational systems are discussed by Victoria Perry in “Adaptive Web-Based Learning Environments” available at http://www.usability.gov/articles/012010news.html (available as of Mar. 12, 2012).

Computerized competency assessments are likewise well known. For example, U.S. Pat. No. 5,421,730 teaches interactive learning systems that provide feedback based on user entries in response to system generated questions. Other systems assess whether a user has achieved a particular learning objective, as for example U.S. Pat. No. 7,980,855 which teaches a computer implemented method for reporting student progress in an academic or other learning domain.

Electronic learning systems that train, adapt and certify are currently unavailable. Accordingly, what is needed is a system for providing adaptive content, assessing and certifying that particular learning targets have been achieved via a device that can be deployed over mobile systems such as iPad, tablets and mobile devices as well as via the desktop or laptop computers.

### SUMMARY OF THE INVENTION

The present invention provides these and other characteristics.

In accordance with the present invention, there is provided an electronic training and certification system comprising:
A content publishing module having
   a content publishing database having a text content database and means for converting the text content database to a video content database having internet and mobile compatible video format, the content publishing module including a learning node associated with at least one learning target and at least one presentation means;
An adaptive learning module having
   means for ascertaining and adapting to the learning needs of a user;
A delivery module having
   a program admission node which allows a user to access content in the content publishing module based on the identity of the user and authorization given to the user by the system as determined by subscription rights ascribed to the user, the delivery module further including means for a user to interact with the system;
   a certification node including an assessment node, means to identify if the user has attained the at least one learning target associated with the learning node, the certification module further means to provide notification to the delivery module that the user has been granted a certification associated with the learning target; and
   an analytics node having means to analyze user data and provide reports related thereto,
      wherein the system provides and certifies a users knowledge of regulations and laws via a device that can be deployed over a mobile system or the Internet.

### BRIEF DESCRIPTION OF THE DRAWINGS

FIG. 1 is an example of a functional block diagram of an electronic system for training and certification.

FIG. 2 is an example of a functional block diagram of a content publishing module.

FIG. 2A is an example of a functional block diagram of an adaptive learning module.

FIG. 3 illustrates an example of a structured logic response.

FIG. 3A illustrates an example of content specific questions and answers associated with target learning components.

### DETAILED DESCRIPTION OF THE PREFERRED EMBODIMENTS

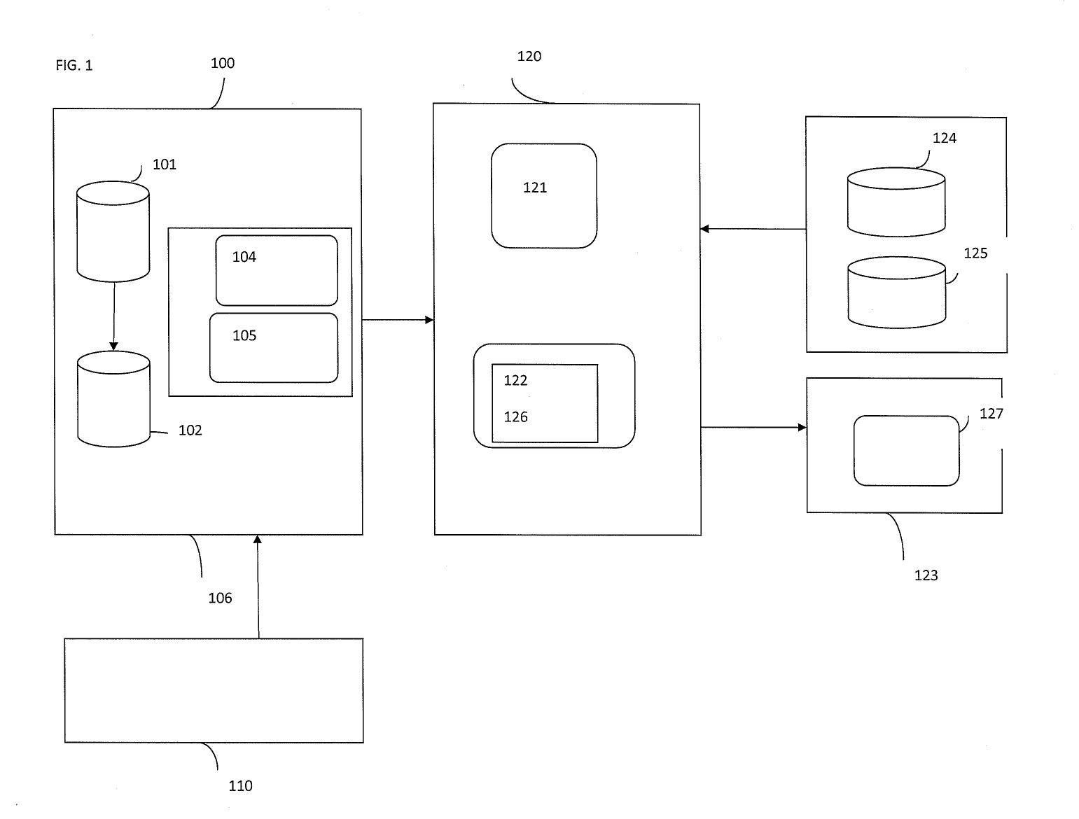

Referring now to FIG. 1, there is provided a functional block diagram of an electronic system for training and certification according to one aspect of the present invention. Content publishing module (100) comprises a database of original documentary content, as for example, a business learning program. The learning program may provide content necessary to deploy across an organization, such as an anti-harassment training program, or across an academic setting. Content publishing module includes a text content database (101) which contains one or more series of target knowledge content, a video content database (102), means for converting the text content to video content, and a database for storing the video content (103). Conversion of text to video can take place by any data conversion tool such as those offered by Zanzar LC (England). In a preferred embodiment, video content can be optimized for delivery to mobile devices such as iPhones, iPads, tablets, Android devices, blackberry devices and the like.

The testing and certification system is stored in a remote database and deployed over a secure connection via the Internet to an electronic device such as a desktop or laptop computer, having a processor and memory, with user inputs, such as a keyboard and mouse, and outputs for viewing information. In another embodiment, the system provides an integrated application for accessing testing and certification services using portable electronic devices. In this embodiment, the electronic device can include any suitable type of electronic device (e.g., iPhones and iPads (Apple, Inc., Cupertino, Calif.), Android (Google, Mountainview, Calif.), any type of tablet-style computer, or Blackberry devices (RIM, Waterloo, Canada)) which securely connects to one or more servers associated with the remote database to provide the system of the invention to the electronic device. Electronic device components and functionality are well known in the art and readily usable with the present invention.

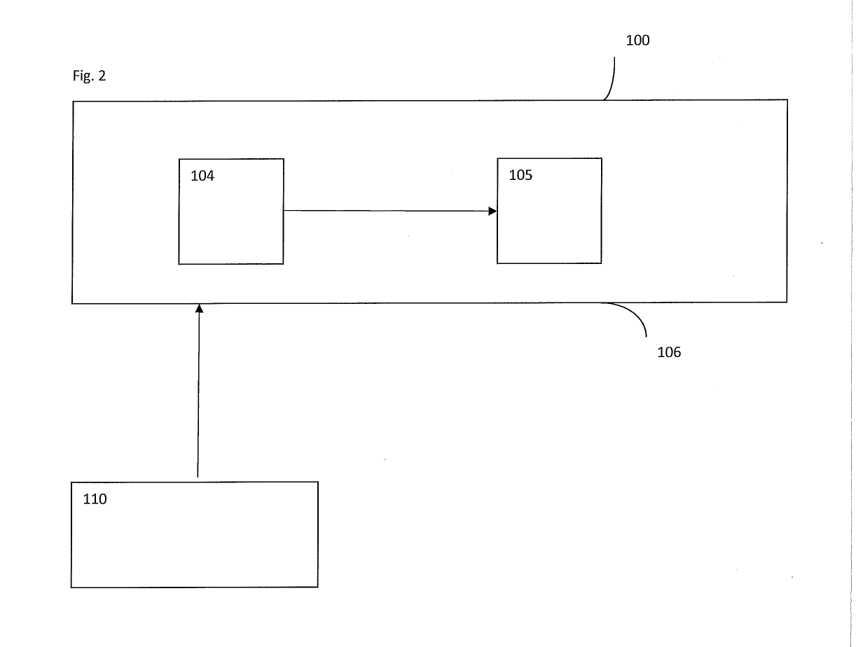

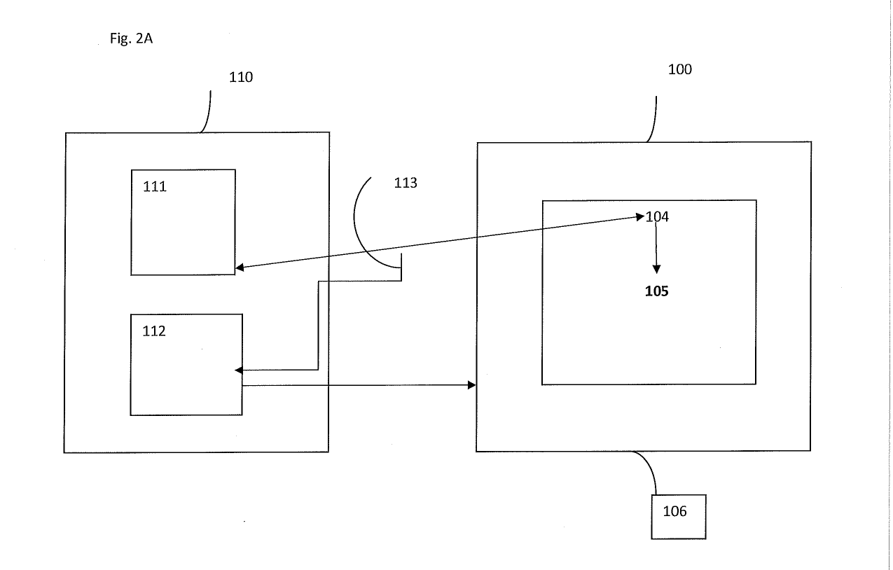

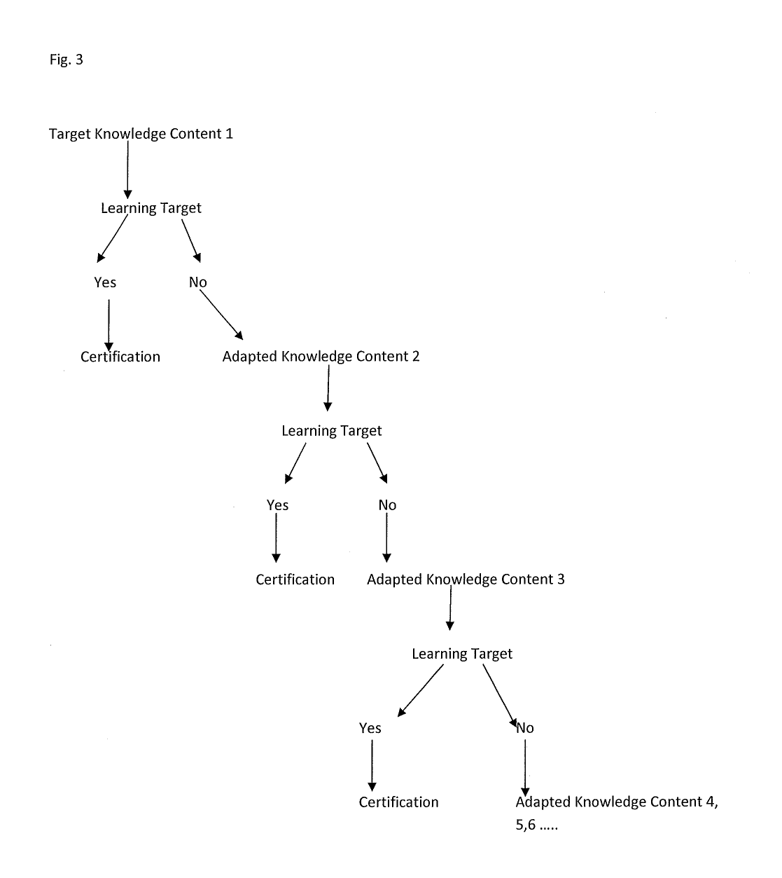

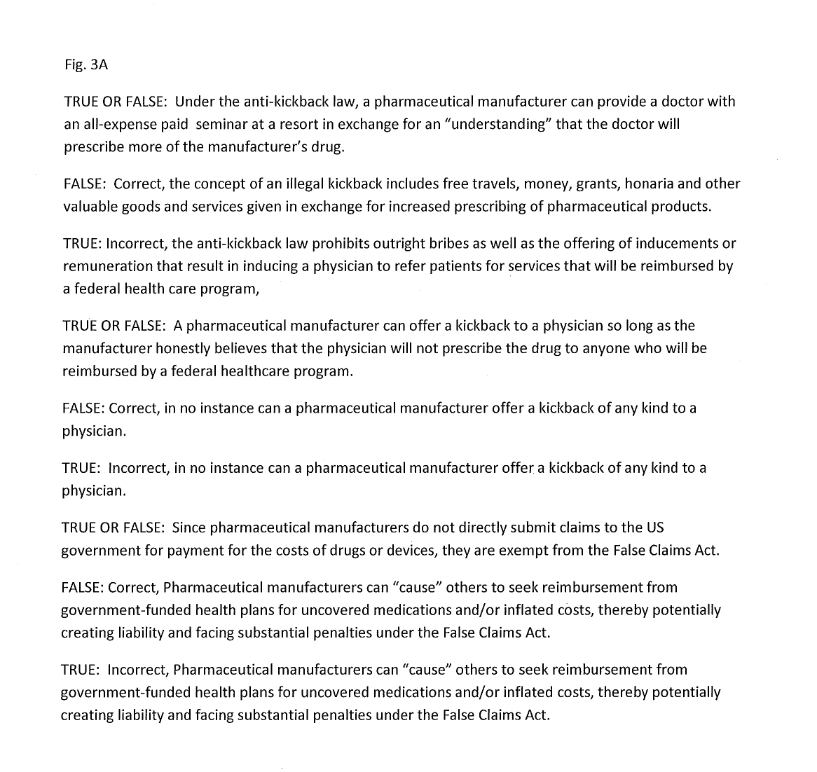

As shown in FIG. 2, content publishing module (100) also includes a learning node (104) with at least one presentation means (105). The learning node (104) can have one more learning targets associated with a specific level of knowledge content mastery. For example, if the knowledge content group describes rules and regulations relating to compliance in a given industry, the learning target may be correct answers to specific questions relating to the subject matter. More specifically, learning node (104) compares the learner response to a pre-prescribed keyword response in the text content database to determine if the learner has successfully mastered the knowledge content. If the learner has not mastered the text content, the system interacts with adaptive learning module (110) to present the target knowledge content via a different means. As illustrated in FIG. 3, if the user satisfies the learning target after presentation of the content, a certification, described fully described later, will be awarded. If the user is unable to meet the learning target, the learning node provides the user with the target knowledge content arranged for different user learning styles.

Referring to FIG. 2A, adaptive learning module (110) includes evaluation node (111) which interacts with learning node (104) via evaluation controller (113) to create a learning file (112). Learning file 112 stores the results of the users response to the initial course content and generates a course content presentation based on structured logic response as depicted in FIG. 3. The structured logic response may be based on any adaptive learning system known in the art such as described in Chen, C.-M., Lee, H.-M., & Chen, Y.-H. (2005). Personalized e-learning system using Item Response Theory. Computers & Education, 44, 237-255; Sessink, O. D. T., Beeftink, H. H., Tramper, J., & Hartog, R. J. M. (2007). Proteus: a lecturer-friendly adaptive tutoring system. Journal of Interactive Learning Research, 18 (4), 533-554; and Magoulas, G. D., Papanikolaou, K., & Grigoriadou, M. (2003). Adaptive web-based learning: accommodating individual differences through system's adaptation. British Journal of Educational Technology, 34 (4), 511-527. Evaluation node (111) generates a positive response once a learning target is achieved. This positive response is communicated to learning node (104) and, ultimately, the learner, via user interface (106).

Learning file 112 interacts with presentation means 105 via user interface 106 for providing the presentation and interaction with the learner, it being understood that user interface 106 may be implemented using commercially available software including, but not limited to a web browser. The adaptive learning system 110 operates in conjunction with standard software and may be stored in memory, or as otherwise appropriate for efficient operation.

Referring more specifically to FIG. 3A, illustrated are example question formats. The target knowledge component is presented to the learner, followed by a series of test questions. The test questions may take the form of multiple choice, as illustrated in FIG. 3A, or other question/answer formats. It is understood that the test questions can be tailored to the target knowledge content and learning target (104) as described more fully below.

As an example of the system of the present invention, content publishing module (100) delivers target knowledge content followed by a series of test questions as defined by the system administrator via user interface (106). Learning node (104) compares a learner response to a pre-prescribed keyword response in the text content database to determine if the learner has successfully mastered the knowledge content. Upon initial use of the system, learning node (104) presents the user with a standardized format of the target knowledge content via the user interface (106). If the learner has achieved the learning target, the system provides a certification as more fully described below. If the learner has not mastered the text content, the system interacts with adaptive learning module (110) to present the target knowledge content adapted in an alternative presentation means (105). The system continues to interact with adaptive learning module (110) until a positive response is generated by evaluation node (111) once the learning target is achieved and this is transmitted to learning node (104). In this way, the system is able to provide the user with as many or as little number of learning formats necessary to achieve mastery of the learning content. The system works in a continuous loop so that that the user interacts with the content via differing presentation means which enables the user to assimilate the content in a way most conducive to learning for the individual user.

In another embodiment, the each additional learning target is cumulative to the previous target, that is, additional content, which builds up the content delivered in the first target, can be delivered and assessed. In this way, the system can be adapted to provide a user with cumulative target knowledge content. By way of example, the system can provide target knowledge content associated with an initial learning target that a learner must satisfy. Once this learning target is achieved, the system then moves to a second learning target which may be based on similar, but more detailed knowledge, or similar, but sequentially target knowledge content.

Referring back to FIG. 1, the system also includes delivery module (120). Delivery module (120) includes program admission node (121), certification node (122), and analytics node (123). Program admissions node (121) is configured to admit users to the system based on their system authorization. In one embodiment, program admissions node (121) comprises a database of approved system users (124) accorded access to specific content based on authorization, and administrator database (125). The administrator database (125) interacts with the user database (124) such that a person having administrator access can specify user permissions. The administrator database (125) can be deploying using any commercially available software or system. Delivery module (120) operates in conjunction with content publishing module (100) via standard software or otherwise as known in the art.

Certification node (122) interacts with learning node (104) to receive information regarding a users satisfaction of a learning target. Certification node contains a system controller (126) which connects the certification node to the content publishing module (100), and more specifically, the learning node. System controller (126) receives a prompt from learning node (104) once the learner meets a learning target. The prompt causes system controller (104) to generate a message that is transmitted back to the learning node and, ultimately, the learner that the learner has satisfied a certification criteria and will be awarded a certification for the target knowledge content.

Referring back to FIG. 1, delivery module (120) includes analytics node (123) coupled to learning node (104) and certification node (122) by analytics controller (127) for tracking, analyzing and reporting data. Analytics node comprises analytics systems well-known in the art and easily adapted to the present invention. For example, U.S. Patent Application Publication No. 2011/106496 provides systems and products for automated collection and storage of test data, as well as automated test performance indicator determinations and automated test result information delivery. Likewise, many commercial products are available that provide analytics rigor to any type of data set. These can be Internet-based or available on mobile platforms. Any one of the systems can be adapted and used in the present invention.

It is understood that any commercially available software or methods may be used to implement any aspect of the system of the present invention.

1. An electronic training and certification system comprising:
A content publishing module having
a content publishing database having a text content database and means for converting the text content database to a video content database having internet and mobile compatible video format, the content publishing module including a learning node associated with at least one learning target and at least one presentation means;
An adaptive learning module having
means for adapting to the learning needs of a user;
A delivery module having
a program admission node which allows a user to access content in the content publishing module based on the identity of the user and authorization given to the user by the system as determined by subscription rights ascribed to the user, the delivery module further including means for a user to interact with the system; and
a certification node including an assessment node, means to identify if the user has attained the at least one learning target associated with the learning node, the certification module further means to provide notification to the delivery module that the user has been granted a certification associated with the learning target, wherein the system provides and certifies a users achievement of at least one learning target.

2. The system of claim 1 further comprising an analytics node having means to analyze user data and provide reports related thereto.

3. The system of claim 1 wherein the at least one learning target comprises regulations and laws associated with a regulated industry.

4. The system of claim 1 that can be deployed over a mobile system or the Internet.

5. The system of claim 1 wherein the adaptive learning module has means for ascertaining the learning needs of a user.

6. The system of claim 1 wherein the each additional learning target is achieved only upon satisfaction of the previous learning target.

7. The system of claim 1 further comprising means for presenting different learning content format based on a users response to the system.

8. The system of claim 1 wherein the user can control the presentation of the learning content.

9. An electronic device comprising means that allow a user to interface with a training and certification system operable to provide a user with at least one knowledge content and means to test user satisfaction with the knowledge content and provide certification of successful knowledge content satisfaction.
